(19) United States
(12) Patent Application Publication
(10) Pub. No.: US 2020/0005199 A1
(43) Pub. Date: Jan. 2, 2020

(54) VACANCY MANAGEMENT SYSTEM, VACANCY MANAGEMENT METHOD, AND PROGRAM

(71) Applicant: OPTiM Corporation, Saga-shi (JP)

(72) Inventor: Shunji SUGAYA, Tokyo (JP)

(21) Appl. No.: 16/461,092

(22) PCT Filed: Jul. 27, 2016
(86) PCT No.: PCT/JP2016/072023

§ 371 Date: Jul. 10, 2019

(51) Int. Cl. G06Q 10/02; G06Q 30/06; G06T 7/70; G06K 9/00

(52) U.S. Cl. CPC G06Q 10/02; G06Q 30/0635; G06Q 50/12; G06K 9/00369; G06T 7/70

(57) ABSTRACT

An object of the present invention is to provide a vacancy management system, a vacancy management method, and a program that improve convenience while suppressing costs. A vacancy management system 1 for managing a vacant seat by performing image analysis on a captured image captured by a camera 100 acquires the captured image, performs image analysis on the acquired, captured image, detects how many chairs exist in a table based on an analysis result of the image analysis, detects whether a person is sitting in the chairs based on the analysis result of the image analysis, and a vacant seat information display unit that displays vacant seat information based on a number of detected chairs and presence or absence of the detected person.

### TECHNICAL FIELD

The present invention relates to a vacancy management system, a vacancy management method, and a program for managing vacant seats by performing image analysis on a captured image captured by a camera.

### BACKGROUND ART

In recent years, there is a system which provides various sensors such as a weight sensor are provided in a chair in a public transportation facility, a restaurant or the like, and determines whether this chair is vacant from the detection result of the sensor. In such a system, it is possible to notify vacant seat information to a user by transmitting the determination result to a customer terminal or the like possessed by the user.

In such a vacancy management system, a management device transmits a measurement instruction to the various sensors, and the various sensors transmit to the management device a detection result which is detected based on this instruction. The management device determines whether a seat is vacant based on the detection result, and transmits a position of the vacant seat to the terminal (see Patent Document 1).

### PRIOR ART DOCUMENT

### Patent Document

Patent Document 1: Japanese Patent Application Publication No. 2013-222358

### SUMMARY OF THE INVENTION

### Technical Problem

However, in the configuration of Patent Document 1, since it is necessary to provide a sensor for each chair, there is a problem that the cost increases to manage vacancies of all the chairs. In addition, when the customer places his/her own luggage on the chair, the chair may be determined to be sat by a person despite the fact that the chair is actually vacant, depending on the weight of the luggage. Thus, there is a problem that the convenience is low.

An object of the present invention is to provide a vacancy management system, a vacancy management method, and a program that improve convenience while suppressing costs.

### Technical Solution

The present invention provides the following solutions.

The invention according to a first aspect provides a vacancy management system that manages a vacant seat by performing image analysis on a captured image captured by a camera, the vacancy management system including a captured image acquiring unit that acquires the captured image, an image analysis unit that performs image analysis on the acquired, captured image, a first detecting unit that detects how many chairs exist in a table based on an analysis result of the image analysis, a second detecting unit that detects whether a person is sitting in the chairs based on the analysis result of the image analysis, and a vacant seat information display unit that displays vacant seat information based on a number of detected chairs and presence or absence of the detected person.

According to the first aspect of the invention, a vacancy management system for managing a vacant seat by performing image analysis on a captured image captured by a camera acquires the captured image, performs image analysis on the acquired, captured image, detects how many chairs exist in a table based on an analysis result of the image analysis, detects whether a person is sitting in the chairs based on the analysis result of the image analysis, and displays vacant seat information based on a number of detected chairs and presence or absence of the detected person.

Here, the invention according to the first aspect is a category of a vacancy management system, but even in other categories such as a method or a program, exhibits the same action and effect corresponding to the category.

An invention according to a second aspect provides the vacancy management system which is the invention according to the first aspect, wherein the vacant seat information display unit changes and displays a degree of attention when all of the detected chairs are vacant.

According to the second aspect of the invention, the vacancy management system, which is the invention according to the first aspect, changes and displays a degree of attention when all of the detected chairs are vacant.

An invention according to a third aspect provides the vacancy management system which is the invention according to the first aspect, wherein the vacant seat information display unit that displays how many vacant seats exist in the table.

According to the third aspect of the invention, the vacancy management system, which is the invention according to the first aspect, displays how many vacant seats exist in the table.

An invention according to a fourth aspect provides the vacancy management system, which is the invention according to the first aspect, further including a third detecting unit that detects attribute information of the person sitting in the chairs based on the analysis result of the image analysis, and an attribute information display unit that displays the detected attribute information.

According to the fourth aspect of the invention, the vacancy management system, which is the invention according to the first aspect, detects attribute information of the person sitting in the chairs based on the analysis result of the image analysis, and displays the detected attribute information.

An invention according to a fifth aspect provides the vacancy management system, which is the invention according to the first aspect, further including a user terminal registration unit that registers a user terminal, and a notification unit that notifies the registered user terminal of the vacant seat information.

According to the fifth aspect of the invention, the vacancy management system, which is the invention according to the first aspect, registers a user terminal, and notifies the registered user terminal of the vacant seat information.

The invention according to a sixth aspect provides a vacancy management method that manages a vacant seat by performing image analysis on a captured image captured by a camera, the vacancy management method including acquiring the captured image, performing image analysis on the acquired, captured image, detecting how many chairs exist in a table based on an analysis result of the image analysis, detecting whether a person is sitting in the chairs based on the analysis result of the image analysis, and displaying vacant seat information based on a number of detected chairs and presence or absence of the detected person.

The invention according to a seventh aspect provides a program for causing a vacancy management method that manages a vacant seat by performing image analysis on a captured image captured by a camera to execute acquiring the captured image, performing image analysis on the acquired, captured image, detecting how many chairs exist in a table based on an analysis result of the image analysis, detecting whether a person is sitting in the chairs based on the analysis result of the image analysis, and displaying vacant seat information based on a number of detected chairs and presence or absence of the detected person.

### Effects of the Invention

According to the present invention, it is possible to provide a vacancy management system, a vacancy management method, and a program that improve convenience while suppressing costs.

### BRIEF DESCRIPTION OF THE DRAWINGS

FIG. 1 is a diagram showing an overview of a vacancy management system 1.

FIG. 2 is an overall configuration diagram of a vacancy management system 1.

FIG. 3 is a functional block diagram of a computer 10, a camera 100, and a user terminal 200.

FIG. 4 is a flowchart showing a registration process performed by a computer 10 and a user terminal 200.

FIG. 5 is a flowchart showing an image-capturing process executed by a computer 10 and a camera 100.

FIG. 6 is a flowchart showing a vacancy management process executed by a computer 10.

FIG. 7 is a flowchart showing a vacancy management process executed by a computer 10.

FIG. 8 is a flowchart showing vacancy seat management process executed by a computer 10.

FIG. 9 is a flowchart showing a vacant seat display process executed by a user terminal 200.

FIG. 10 is a diagram showing an example of a result of image analysis executed by a computer 10.

FIG. 11 is a diagram showing an example of a result of image analysis executed by a computer 10.

FIG. 12 is a diagram showing an example of a message displayed by a user terminal 200.

FIG. 13 is a diagram showing an example of a seat confirmation screen displayed by a user terminal 200.

FIG. 14 is a diagram showing an example of a message displayed by a user terminal 200.

FIG. 15 is a diagram showing an example of an other store introduction screen displayed by a user terminal 200.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

Overview of Vacancy Management System 1

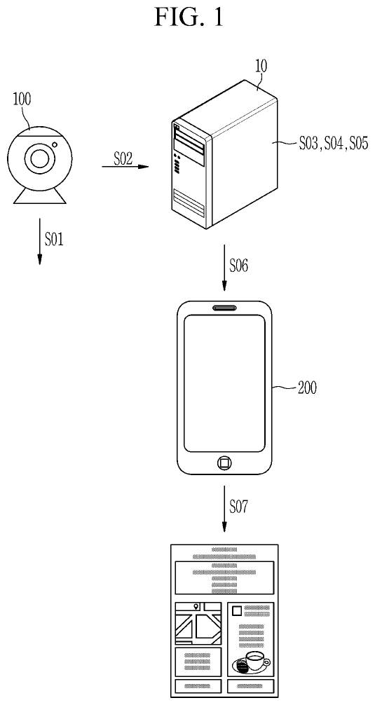

An overview of the present invention is described based on FIG. 1. FIG. 1 is a diagram for explaining an overview of a vacancy management system 1 according to a preferred embodiment of the present invention. The vacancy management system 1 includes a computer 10, a camera 100, and a user terminal 200. The number of camera(s) 100 and the number of user terminal(s) 200 are not limited to one, and may be two or more. In addition, each process to be described below may be realized by any one or a combination of two or more of the computer 10, the camera 100, and the user terminal 200.

The computer 10 is a computer device capable of performing data communication with the camera 100 and the user terminal 200.

The camera 100 is an image-capturing device such as a network camera, capable of performing data communication with the computer 10. The camera 100 is provided inside a facility such as a restaurant, and captures a table, a chair, a person, or the like in the facility as a captured image such as a moving image or a still image.

The user terminal 200 is a terminal device capable of performing data communication with the computer 10 and possessed by a user. The user terminal 200 is, for example, a mobile phone, a portable information terminal, a tablet terminal, a personal computer, a netbook terminal, a slate terminal, a wearable terminal such a smart glasses or a head mounted display, or other goods.

First, the camera 100 captures a captured image (step S01). The camera 100 captures an image of a table and a chair belonging to the table. At this time, the camera 100 may be configured to capture one table, or may be configured to capture all the tables in the facility and chairs belonging to each table. When the camera 100 captures one table, the camera 100 may be provided for each table.

The camera 100 transmits captured image data, which is data of the captured image, to the computer 10 (step S02).

The computer 10 acquires the captured image captured by the camera 100 by receiving the captured image data transmitted by the camera 100.

The computer 10 analyzes the captured image data (step S03). The computer 10 analyzes positions and the number of tables, positions and the number of chairs belonging to each table, positions and the number of customers, and the like.

The computer 10 detects how many chairs belong to the table based on the result of the image analysis (step S04). When there are the plurality of tables, the computer 10 detects how many chairs exist for each table.

The computer 10 detects whether a person is sitting in the detected chair based on the result of the image analysis (step S05).

The computer 10 may be configured to detect attribute information such as an entrance time, order details, a purchase price, or a staying time of the person sitting in the chair based on the result of the image analysis. For example, the computer 10 may detect the entrance time and the staying time by detecting a time when the person sits in the chair and detecting a current time. In addition, for example, the computer 10 may detect the order details or the purchase price by analyzing the food or drink placed on the table.

The computer 10 creates vacant seat information such as a vacant table and a vacant chair based on the number of chairs and the presence or absence of a person, and notifies the user terminal 200 of the vacant seat information (step S06).

The computer 10 may be configured to accept registration of the user terminal 200 in advance and to notify the user terminal 200 whose registration has been accepted of the vacant seat information.

The user terminal 200 receives the vacant seat information. The user terminal 200 displays the received vacant seat information (step S07). The user terminal 200 displays the positions of the tables and chairs of the facility, and distinguishes and displays a chair in which a person is not sitting and a chair in which a person is sitting.

In addition, the user terminal 200 may be configured to change and display the degree of attention when all the chairs are vacant. Further, the user terminal 200 may be configured to display attribute information of a person sitting in a chair. Furthermore, the user terminal 200 may be configured to display how many vacant seats exist in the table.

The above is the overview of the vacancy management system 1.

System Configuration of Vacancy Management System 1

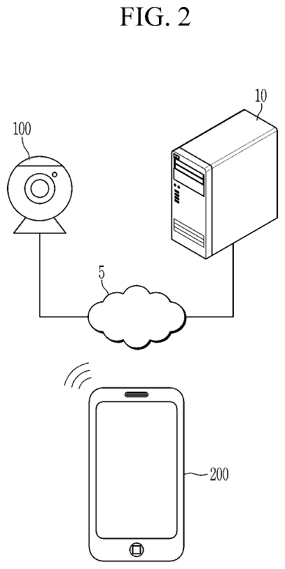

A system configuration of the vacancy management system 1 is described based on FIG. 2. FIG. 2 is a diagram showing a system configuration of a vacancy management system 1 according to a preferred embodiment of the present invention. The vacancy management system 1 includes a computer 10, a camera 100, a user terminal 200, and a public network (an Internet network, a third or fourth generation communication networks, or the like) 5. The number of camera(s) 100 and the number of user terminal(s) 200 is not limited to one, and may be two or more. In addition, each process to be described below may be realized by any one or a combination of two or more of the computer 10, the camera 100, and the user terminal 200. Further, each device may be realized by an existing device or a virtual device.

The computer 10 is the above-described computer device having functions to be described below.

The camera 100 is the above-described image-capturing device having functions to be described below.

The user terminal 200 is the above-described terminal device having functions to be described below.

Description of Each Function

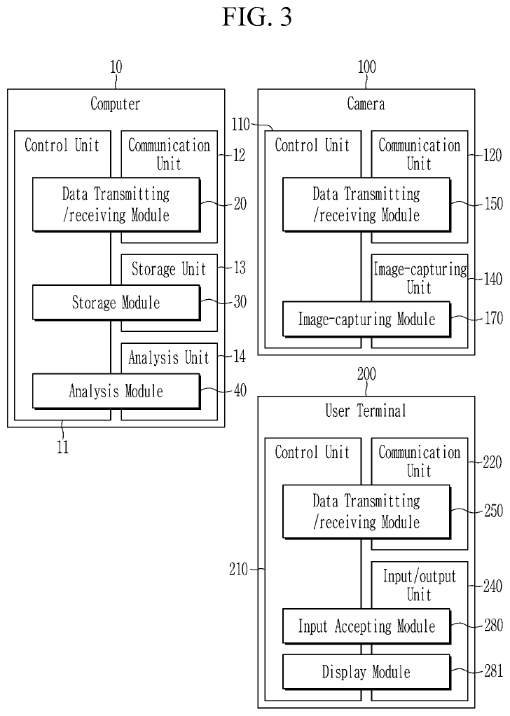

Functions of a vacancy management system 1 are described based on FIG. 3. FIG. 3 is a functional block diagram of a computer 10, a camera 100, and a user terminal 200.

The computer 10 includes, as a control unit 11, a CPU (Central Processing Unit), a RAM (Random Access Memory), a ROM (Read Only Memory), and the like. In addition, the computer 10 includes, as a communication unit 12, a device for enabling communication with other devices, for example, a WiFi (Wireless Fidelity) compliant device conforming to IEEE 802.11 like. Further, the computer 10 includes, as a storage unit 13, a data storage device such as a hard disk, a semiconductor memory, a recording medium, a memory card, or the like. Furthermore, the computer 10 includes, as an analysis unit 14, an analysis device for executing image analysis of the acquired captured image or the like.

In the computer 10, the control unit 11 reads a predetermined program, thereby realizing a data transmitting/receiving module 20 in cooperation with the communication unit 12. In addition, in the computer 10, the control unit 11 reads a predetermined program, thereby realizing a storage module 30 in cooperation with the storage unit 13. Further, in the computer 10, the control unit 11 reads a predetermined program, thereby realizing an analysis module 40 in cooperation with the analysis unit 14.

Like the computer 10, the camera 100 includes, as a control unit 110, a CPU, a RAM, a ROM, and the like, and includes, as a communication unit 120, a device for enabling communication with other devices or the like. In addition, the camera 100 includes, as an image-capturing unit 140, an image-capturing device such as a lens, an image pickup device, various buttons, a flash, and the like.

In the camera 100, the control unit 110 reads a predetermined program, thereby realizing a data transmitting/receiving module 150 in cooperation with the communication unit 120. In addition, in the camera 100, the control unit 110 reads a predetermined program, thereby realizing an image-capturing module 170 in cooperation with the image-capturing unit 140.

Like the computer 10, the user terminal 200 includes, as a control unit 210, a CPU, a RAM, a ROM, and the like, and includes, as a communication unit 220, a device for enabling communication with other devices or the like. In addition, the user terminal 200 includes, as an input/output unit 240, a display unit for outputting and displaying data and images controlled by the control unit 210, an input unit such as a touch panel, a keyboard, a mouse, or the like for accepting an input from a user.

In the user terminal 200, the control unit 210 reads a predetermined program, thereby realizing a data transmitting/receiving module 250 in cooperation with the communication unit 220. In addition, in the user terminal 200, the control unit 210 reads a predetermined program, thereby realizing an input accepting module 280 and a display module 281 in cooperation with the input/output unit 240.

In the following description, although each device of the camera 100 and the user terminal 200 is described as one device, but the present process can be executed even if a plurality of devices are provided.

Registration Process

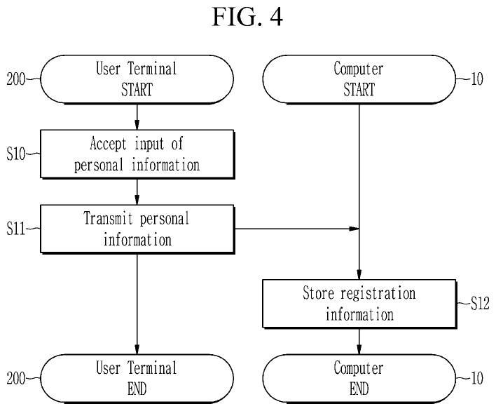

A registration process executed by a vacancy management system 1 is described based on FIG. 4. FIG. 4 is a flowchart of a registration process executed by a computer 10 and a user terminal 200. A process executed by modules of each device described above is described together with the present process.

First, an input accepting module 280 accepts an input from a user, and accepts an input of personal information necessary for user registration (step S10). The input accepting module 280 accepts the input of personal information, such as a user's name, telephone number, or e-mail address, the number of visitors, a visiting time, or the like, on an input form for registration acquired from the computer 10 or the like.

The processing of step S10 may be executed by a terminal device other than the user terminal 200. For example, it may be configured that the user inputs the above-described personal information to the terminal device installed in a facility. In this case, the terminal device may be configured to transmit the personal information which has been accepted as the input to the computer 10.

A data transmitting/receiving module 250 transmits the personal information which has been accepted as the input to the computer 10 (step S11). In step S11, in addition to the personal information, the data transmitting/receiving module 250 transmits terminal-specific information unique to the terminal, such as its own terminal number, manufacturing number, or MAC address.

A data transmitting/receiving module 20 receives the personal information and the terminal-specific information. A storage module 30 stores the received personal information and terminal-specific information as registration information (step S12).

In addition, in step S12, the storage module 30 may be configured to store only the personal information as registration information. Further, the personal information which the input accepting module 280 has accepted as the input is not limited to the above-described configuration, and may be appropriately changed.

The above is the registration process.

Image-Capturing Process

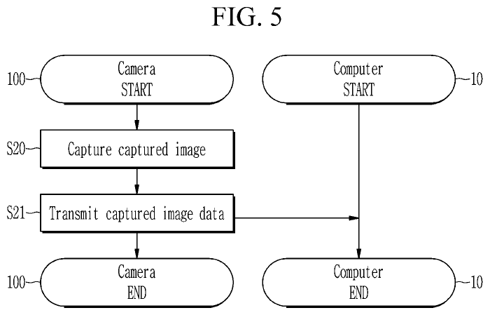

An image-capturing process executed by a vacancy management system 1 is described based on FIG. 5. FIG. 5 is a diagram showing a flowchart of an image-capturing process executed by a computer 10 and a camera 100. A process executed by modules of each device described above is described together with the present process.

An image-capturing module 170 captures a captured image such as a moving image or a still image in a facility such as a restaurant (step S20). In step S20, the image-capturing module 170 constantly captures the captured image. The camera 100 is provided at a position where it can overlook the inside of the facility, and captures all of tables present in the facility and chairs belonging to the tables.

In step S20, it may be configured that a plurality of cameras 100 are provided in the facility and each camera 100 captures one corresponding table or a plurality of corresponding tables and chairs belonging to the table(s). In this case, the cameras 100 corresponding to the number of tables may be added to the vacancy management system 1. In addition, the image-capturing module 170 may capture a captured image at predetermined time intervals, for example, every five minutes, every ten minutes, or the like.

A data transmitting/receiving module 150 transmits captured image data, which is data of the captured image, to the computer 10 (step S21). In step S21, the data transmitting/receiving module 150 adds a current time to the captured image data, and transmits them to the computer 10.

The computer 10 receives the captured image data. The computer 10 acquires the captured image captured by the camera 100 by receiving the captured image data.

In addition, in step S21, the data transmitting/receiving module 150 may be configured to transmit only the captured image data to the computer 10. In addition, the data transmitting/receiving module 150 may be configured to add data or information other than the above-described configuration and transmit them to the computer 10.

The above is the image-capturing process.

Vacancy Management Process

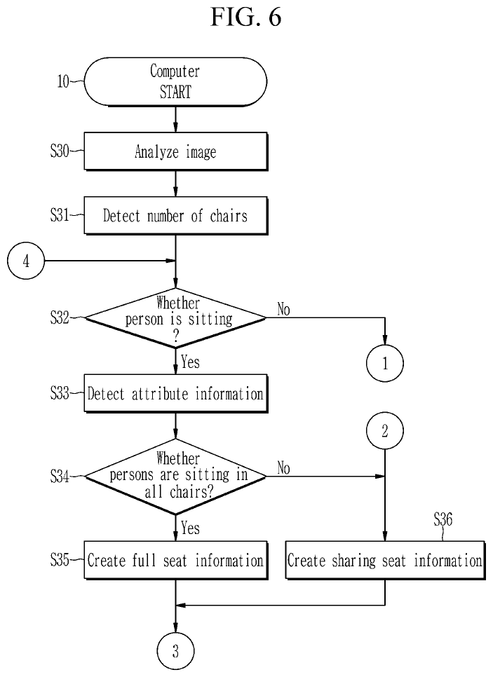

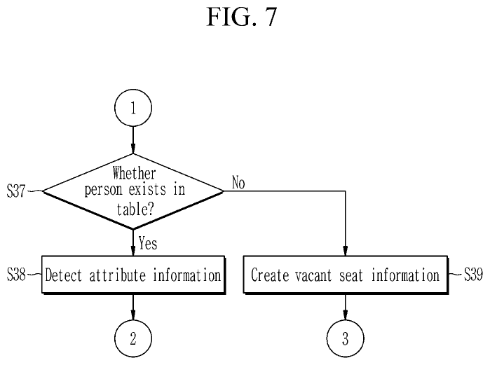

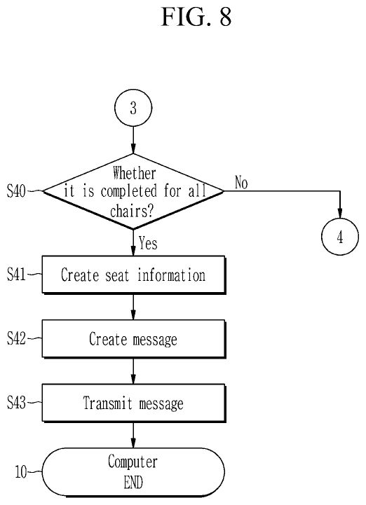

A vacancy management process executed by a vacancy management system 1 is described based on FIG. 6, FIG. 7, and FIG. 8. FIG. 6, FIG. 7, and FIG. 8 are flowcharts showing a vacancy management process executed by a computer 10. A process executed by each module described above is described together with the present process.

An analysis module 40 analyzes the acquired captured image (step S30). In step S30, the analysis module 40 analyzes positions and the number of tables appearing in the captured image, the number and position of chairs belonging to each table, positions and the number of customers, food and drink placed on the table, and the like. For example, the analysis module 40 analyzes the tables, the chairs, and the customers by extracting features of the captured image. The analysis module 40 determines the vacant seat status of the tables, the number of customers, the order details of the customers, and the like, based on the analysis result.

The analysis module 40 may configured to analyze the table or chair by comparing an image of the table or chair stored in advance with an image of the table or chair analyzed from the captured image. Further, the analysis module 40 may be configured to perform image analysis by another method.

The analysis module 40 detects how many chairs exist in the table appearing in the captured image based on the result of the image analysis (step S31). In step S31, the analysis module 40 detects how many chairs exist for each table appearing in the captured image. When the analyzing module 40 detects, for example, a circular or rectangular table, the analyzing module 40 detects chairs existing around the table as chairs belonging to this table. In addition, for example, the analyzing module 40 detects the rectangular table and detects chairs that exist at positions opposed to each other with the table as chairs belonging to this table. Further, for example, the analyzing module 40 detects the rectangular table and detects chairs arranged along one side as chairs belonging to this table. The analyzing module 40 detects the number and arrangement of chairs for each table.

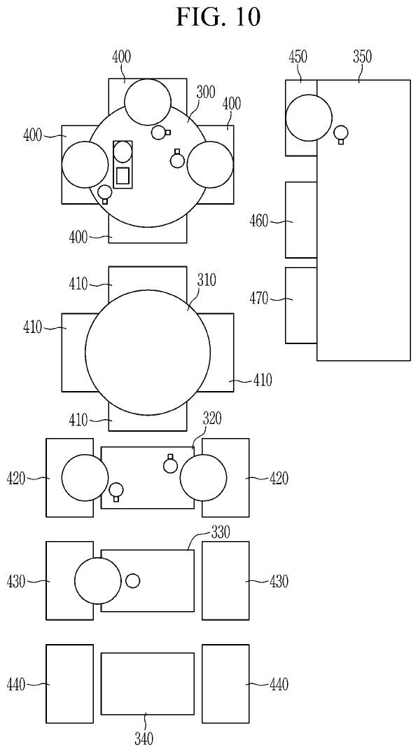

FIG. 10 is a diagram showing an example of a result of image analysis executed by an analysis module 40. In FIG. 10, the analysis module 40 detects the number of tables appearing in the camera image and the number of chairs belonging to each table. In other words, in FIG. 10, the analyzing module 40 detects a first table 300, a second table 310, a third table 320, a fourth table 330, a fifth table 340, and a sixth table 350, as the tables appearing in the camera image. Further, the analyzing module 40 detects four chairs 400 belonging to the first table 300, four chairs 410 belonging to the second table 310, two chairs 420 belonging to the third table 320, two chairs 430 belonging to the fourth table 330, two chairs 440 belonging to the fifth table 340, and chairs 450, 460, and 470 belonging to the sixth table 350.

The analyzing module 40 determines which chair belongs to which table based on the shape or the like of each chair, and detects the chairs belonging to each table. For example, when the table has a circular shape, the analyzing module 40 detects chairs positioned around the circle as the chairs belonging to this table. Further, when the table has a rectangular shape, the analyzing module 40 detects chairs arranged at the surrounding position or the opposing position as the chairs belonging to this table. Furthermore, when the table is the rectangular shape, the analyzing module 40 detects chairs arranged to one side of the rectangle as the chairs of different groups belonging to this table. That is, in FIG. 10, the chairs belonging to each table are handled as one group in the first to fifth tables 300 to 340, but the chairs 450, 460, and 470 are handled as the different group in the sixth table 350.

The analysis module 40 determines whether a person is sitting in the detected chair based on the result of the image analysis (step S32). In step S32, the analysis module 40 determines whether a person is sitting in the chair belonging to one table. In step S32, when the analysis module 40 determines that a person is sitting (YES in step S32), the analysis module 40 detects attribute information of the person sitting in this chair (step S33).

In step S33, the analysis module 40 detects, as attribute information, an entrance time, a staying time, order details, a purchase price, or the like. The analysis module 40 detects the attribute information based on the food or drink placed on the table to which the chair in which the person is sitting belongs, a time when the person is detected for the first time, the entrance time, or the like. The analysis module 40 extracts a feature of the food or drink placed on the table based on the result of the image analysis, and specifies the food or drink based on the extracted feature. The analysis module 40 specifies the purchase price based on a price list or the like associated with the specified food or drink. Further, the analysis module 40 specifies, as the entrance time, the time when it is detected for the first time that the person is sitting in this chair. Furthermore, the analysis module 40 specifies a time from the entrance time to the current time as the staying time.

In addition, the attribute information which the analysis module 40 detects is not limited to the above configuration, and the analysis module 40 may detect other information. Further, the processing of step S33 may be omitted. In this case, after the processing of step S32 is performed, each processing to be described below may be executed.

Further, the data transmitting/receiving module 20 may be configured to transmit the attribute information to a store terminal (not shown). By doing this, it becomes easy for the store terminal to grasp the unit price of the customer, the staying time of the customer, the order details of the customer, and the like, and it becomes easy to obtain information necessary for the facility management.

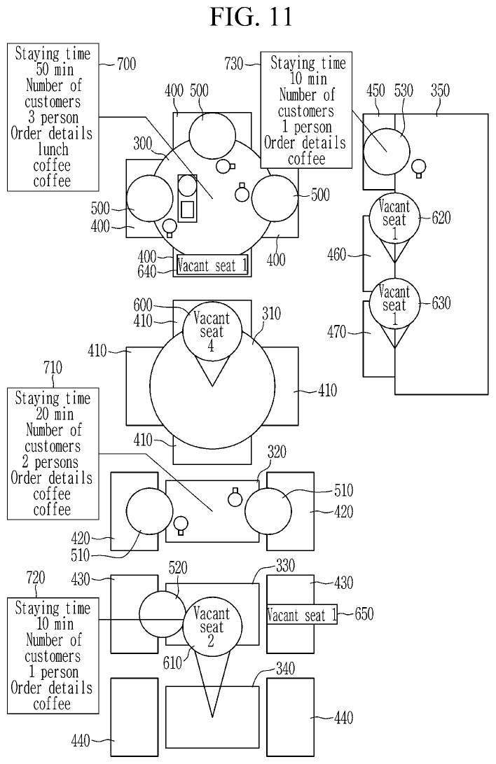

FIG. 11 is a diagram showing an example of a result of image analysis executed by an analysis module 40. FIG. 11 is a diagram for explaining a detection result of persons and a state in which attribute information is detected in the analysis result of FIG. 10. In FIG. 11, the analysis module 40 detects a person for each table and also detects attribute information of each table or person. In FIG. 11, the analysis module 40 detects three persons 500 in a first table 300. In addition, analysis module 40 also detects two persons 510 in a third table 320. Further, one person 520 is detected in a fourth table 330. Furthermore, one person 530 is detected in a sixth table 350.

In FIG. 11, the analysis module 40 detects the staying time of the customer, the number of customers, and the order details, for each table. The analysis module 40 detects the number of persons 500 detected in the first table 300 and the time from the time of the first detection of the person 500 to the current time. The analysis module 40 analyzes the image of the food or drink placed on the table to detect the order details. For example, the analysis module 40 detects a feature of the food or drink, and detects the order details by specifying the order details having a feature that matches the detected feature. The analysis module 40 detects the attribute information such as the staying time, the number of customers, the order details and the like, for each table where the customer exists or for each customer. In FIG. 11, for example, in the first table 300, the analysis module 40 detects the three persons 500, detects that the staying time is 50 minutes, and detects that the order details are lunch, coffee, and coffee. The analysis module 40 associates this attribute information with the first table 300. The analysis module 40 draws a leader line on the first table 300 to indicate that the attribute information 700 is associated. Similarly, in the third table 320, the analysis module 40 detects the two persons 510, detects that the staying time is 20 minutes, and detects that the order details are coffee and coffee. The analysis module 40 draws a leader line on the third table 320 to indicate that the attribute information 710 is associated.

Similarly, in the fourth table 330, the analysis module 40 detects the one person 520, detects that the staying time is 10 minutes, and detects that the order details are coffee. The analysis module 40 draws a leader line on the fourth table 330 to indicate that the attribute information 720 is associated. Similarly, at the sixth table 350, the analysis module 40 detects that the one person 530 is sitting on the chair 450, detects that the staying time is 10 minutes, and detects that the order details are coffee. The analysis module 40 draws a leader line on the person 530 to indicate that the attribute information 730 is associated.

Further, in FIG. 11, a vacant seat icon is shown on the table or chair on which the analysis module 40 cannot detect a person. The analysis module 40 superimposes a vacant seat icon 600 on the second table 310 which no person is detected. In addition, the analysis module 40 superimposes a vacant seat icon 610 on the fifth table 340 in which no person is detected. Further, the analysis module 40 superimposes a vacant seat icon 620 and a vacant seat icon 630 on the chair 460 and the chair 470, respectively, belonging to the sixth table 350, in which no person is detected. The vacant seat icons 600 to 630 also indicate the number of vacant seats in each table.

Furthermore, in FIG. 11, although the analysis module 40 detects the person in the first table 300, the analysis module 40 superimposes a vacant seat icon 640 on the chair 400 which is vacant. Similarly, although the analysis module 40 detects the person in the fourth table 330, the analysis module 40 superimposes a vacant seat icon 650 on the chair 430 which is vacant. The vacant seat icons 640 and 650 indicate the number of shared seats. The analysis module 40 may be configured to superimpose the vacant seat icons on all the vacant chairs. Further, another configuration may indicate that the seat is vacant. Furthermore, vacant seat icons may be superimposed on all the tables where a vacant seat exists.

The analysis module 40 determines whether persons are sitting in all the chairs belonging to one table (step S34). In step S34, the analysis module 40 determines whether the persons are sitting in the chairs around or near one table. In step S34, when the analysis module 40 determines that the persons are sitting in all the chairs (YES in step S34), the analysis module 40 creates full seat information that there is no seat for people to sit at this one table (step S35).

On the other hand, in step S34, when the analysis module 40 determines that all the chairs are not occupied by people (NO in step S34), that is, there is a chair in which a person is sitting and a chair in which a person is not sitting in one table. When it is determined, the analysis module 40 creates sharing seat information that there is a seat for a person to sit at this one table (step S36).

In step S32, when the analysis module 40 determines that no person is sitting (NO in step S32), the analysis module 40 determines whether a person is sitting in a chair around or near one table (step S37). That is, in step S37, it is determined whether there is a person at this one table.

In step S37, when the analysis module 40 determines that a person is sitting (YES in step S37), the analysis module 40 detects attribute information of the person sitting in the chair (step S38). Thereafter, the analysis module 40 creates the sharing seat information described above (step S36).

On the other hand, when it is determined in step S37 that a person is not sitting (NO in step S37), the analysis module 40 creates vacant seat information that this table is vacant (step S39).

The analysis module 40 determines whether the above-described process has been completed for all the chairs (step S40). When the analysis module 40 determines in step S40 that the process has been not completed (NO in step S40), the analysis module 40 executes the processing of step S32 described above again.

On the other hand, when the analysis module 40 determines in step S40 that the process has been completed (YES in step S40), the analysis module 40 creates seat information in which the full seat information, the vacant seat information, and the sharing seat information of each table are summarized (step S41). The seat information is, for example, the vacancy status of each table, the vacancy status for all tables, the attribute information of each table, the attribute information of each person, the estimated remaining staying time, and the like. The estimated remaining staying time is estimated from a staying time according to a number of customers, a staying time according to order details, a staying time according to gender of a customer, and the like, for customers up to now.

The analysis module 40 creates a message including the seat information, a message such as SNS of this facility, a map around this facility, a location of this facility, a link for seat confirmation, a link for introducing other stores, and the like (step S42). Details of this message are described below.

Further, this message does not have to include all the configurations described above. For example, only the seat information may be used, any of the configurations described above may be combined, and other configurations may be added.

Furthermore, a URL for linking to a website including the above-described configuration may be created as the message.

The data transmitting/receiving module 20 transmits the message to the user terminal 200 (step S43). In step S43, the data transmitting/receiving module 20 transmits the message to the user terminal 200 whose registration has been accepted in the above-described registration process. At this time, for example, the data transmitting/receiving module 20 transmits the message to a mail address or telephone number of the user terminal 200 whose registration has been accepted.

In step S43, the data transmitting/receiving module 20 may be configured to transmit the message to the user terminal 200 whose registration has not been accepted. Further, the data transmitting/receiving module 20 may be configured to transmit the seat information and the like to the user terminal 200 by a configuration other than the message. Furthermore, the data transmitting/receiving module 20 may transmit the seat information and the like to the user terminal 200 by another configuration.

The above is the vacancy management process.

Vacant Seat Display Process

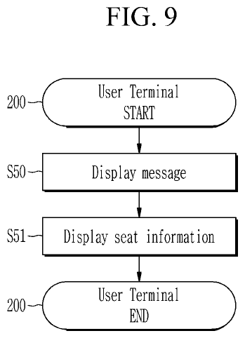

A vacant seat display process executed by a vacancy management system 1 is described based on FIG. 9. FIG. 9 is a diagram showing a flowchart of a vacant seat display process executed by a user terminal 200. A process executed by each module described above is described together with the present process.

A data transmitting/receiving module 250 receives a message. A display module 281 displays the received message (step S50).

An input accepting module 280 accepts an input to a link URL to seat information displayed as the message, a data transmitting/receiving module 250 acquires the seat information, and the display module 281 displays the seat information (step S51).

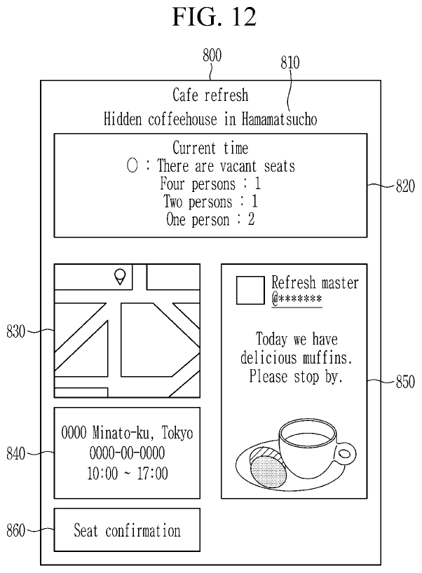

FIG. 12 is a diagram showing an example of a message displayed by a display module 281. In FIG. 12, the display module 281 displays a facility name notification 800, a facility description notification 810, a vacant seat status notification 820, a facility peripheral map 830, a facility information 840, an SNS notification 850, and a seat confirmation icon 860 as a message. The display module 281 displays a name of this facility as the facility name notification 800. Further, the display module 281 displays an explanatory note on the facility as the facility description notification 810. Furthermore, the display module 281 displays, as the vacant seat status notification 820, the presence or absence of a vacant seat, and contents and the number of vacant seats when there are the vacant seats. In addition, the display module 281 displays a peripheral map of the facility as the facility peripheral map 830. Further, the display module 281 displays an address, a telephone number, business hours, and the like of the facility as the facility information 840. Furthermore, the display module 281 displays some of various SNS messages used by the facility as the SNS notification 850.

The input accepting module 280 accepts an input to the seat confirmation icon 860. The display module 281 accepts the input to the seat confirmation icon 860, and displays a seat confirmation screen to be described below.

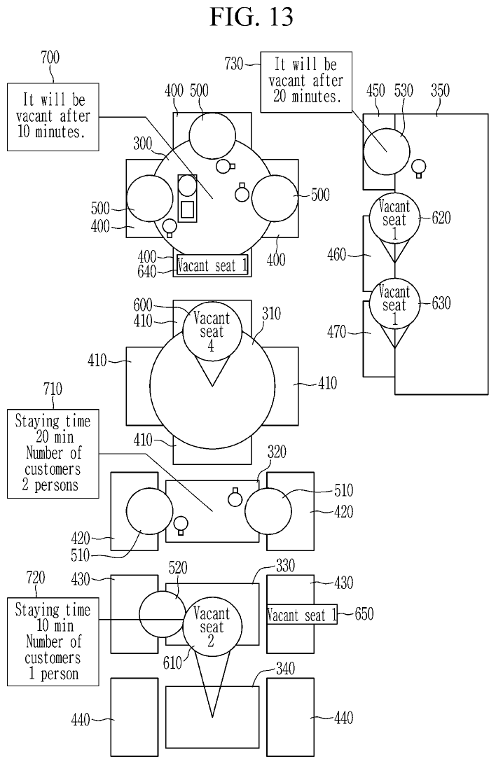

FIG. 13 is a diagram showing an example of a seat confirmation screen displayed by a display module 281. The same reference numerals are designated to the same configurations as those of FIG. 11, and the detailed explanation thereof is omitted. The display module 281 displays a captured image, and tables, chairs, persons, attribute information, and vacant seat icons detected in FIG. 10 and FIG. 11 as the seat confirmation screen.

In FIG. 13, the display module 281 superimposes and displays a vacant seat status of each table and attribute information of a customer who is using each table on the captured image. In FIG. 13, the display module 281 displays that one chair 400 among the four chairs 400 is vacant in the first table 300, by superimposing the vacant seat icon 640 on the chair 400. The display module 281 displays the estimated remaining staying time as the attribute information 700 of the first table 300. The estimated remaining staying time is displayed when the staying time of the customer is a predetermined time, for example, 40 minutes or more, or 50 minutes or more. The display module 281 displays that all of the four chairs 410 are vacant in the second table 310 by superimposing the vacant seat icon 600 on the second table 310. The display module 281 displays how many seats are vacant in the second table 310 by displaying the number of vacant seats on the vacant seat icon 600. The display module 281 displays, as the attribute information 710 of the third table 320, the staying time and the number of customers in the third table 320. The display module 281 displays that one chair 430 of the two chairs 430 is vacant in the fourth table 330 by superimposing the vacant seat icon 650 on the chair 430. The display module 281 displays, as the attribute information 720 of the fourth table 330, the staying time and the number of customers in the fourth table 330. The display module 281 displays that all of the two chairs 440 are vacant in the fifth table 340 by superimposing the vacant seat icon 610 on the fifth table 340. The display module 281 displays how many seats are vacant in the fifth table 340 by displaying the number of vacant seats on the vacant seat icon 610. The display module 281 displays the vacant seat icon and the attribute information on each of the chairs 450, 460, and 470 belonging to the sixth table 350. The display module 281 displays the estimated remaining staying time as the attribute information 730 of the customer sitting in the chair 450. The display module 281 displays that the chair 460 is vacant, by superimposing the vacant seat icon 620 on the chair 460. The display module 281 also displays that the chair 470 is vacant by superimposing the vacant seat icon 630 on the chair 470.

The display module 281 changes a display mode between a case where all the chairs belonging to the table are vacant and a case where some of the chairs belonging to the table are vacant. That is, when all the chairs are vacant, the display module 281 changes and displays the degree of attention.

The message displayed by the display module 281 is not limited to the above-described configuration, and may be another display mode. For example, it may be configured that the display module 281 displays a reservation icon, and the input accepting module 280 accepts an input to the reservation icon and call the facility. In addition, it may be configured that when the input accepting module 280 accepts the input to the reservation icon, the user terminal 200 accesses a website for reservation and transmits contents necessary for the reservation to a computer 10.

Further, the attribute information displayed by the display module 281 is not limited to the above-described configuration, and may be another configuration. For example, the estimated remaining staying time, the staying time, and the number of customers may be displayed as the attribute information, the above-described attribute information detected in FIG. 11 may be displayed, or other information may be displayed.

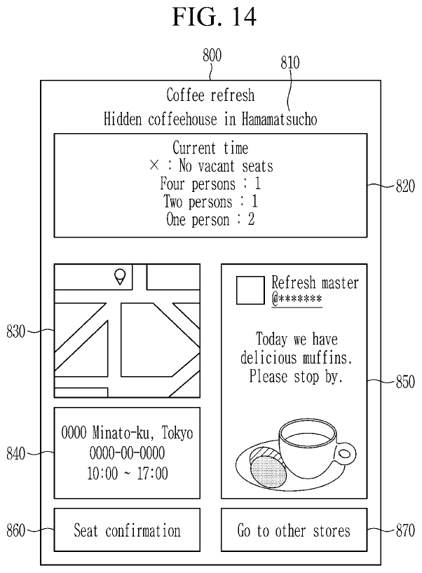

FIG. 14 is a diagram showing an example of a message displayed by a display module 281. The difference between FIG. 12 and FIG. 14 is that FIG. 12 is an example of a message when there is a vacant seat whereas FIG. 14 is an example of a message when there is no vacant seat. In addition, the same reference numerals are designated to the same configurations as those of FIG. 12, and the detailed explanation thereof is omitted.

In FIG. 14, the display module 281 displays the facility name notification 800, the facility description notification 810, the vacant seat status notification 820, the facility peripheral map 830, the facility information 840, the SNS notification 850, and the seat confirmation icon 860 as in FIG. 12. In addition, the display module 281 displays an icon 870 for the other store. An input accepting module 280 accepts an input to the other store icon 870, and displays an other store introduction screen to be described below.

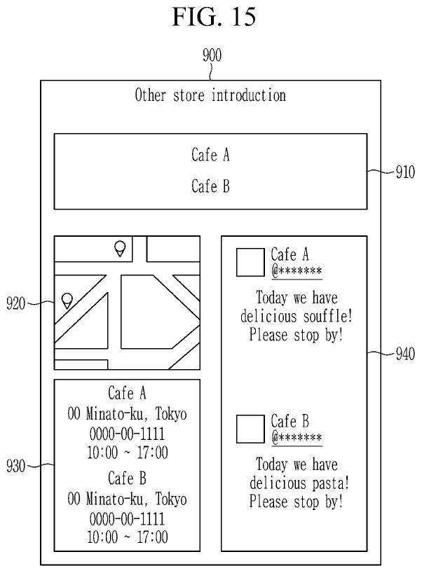

FIG. 15 is a diagram showing an example of an other store introduction screen displayed by a display module 281. In FIG. 15, the display module 281 displays an introduction notification 900, a facility name notification 910, a peripheral map 920, facility information 930, and an SNS notification 940 as the other store introduction screen. The display module 281 displays, as the introduction notification 900, a notification indicating that the screen is for introducing the other store. In addition, the display module 281 displays name(s) of one or more similar facilities around the current location as the facility name notification 910. The display module 281 displays its current location and the position of the facility as the peripheral map 920. Further, the display module 281 displays, as the facility information 930, an address, a telephone number, business hours, and the like of each facility. Furthermore, the display module 281 displays, as the SNS notification 940, some of various SNS messages used by each facility.

The above is the vacant seat display process.

Further, the registration process, the image-capturing process, the vacancy management process, or the vacant seat display process described above is not limited to the above-described configuration in which each module executes each process, and any one or a combination of two or more of the computer 10, the camera 100, and the user terminal 200 may execute each process.

The means and functions described above are realized by reading and executing a predetermined program by a computer (including a CPU, an information processing device, and various terminals). The program is provided, for example, in a form recorded in a computer-readable recording medium such as a flexible disk, a CD (e.g., CD-ROM or the like), a DVD (DVD-ROM, DVD-RAM, or the like), or the like. In this case, the computer reads the program from the recording medium and transfers the program to an internal storage unit or an external storage unit to be stored and executed. Furthermore, the program may be recorded in advance in, for example, a storage device (recording medium) such as a magnetic disk, an optical disk, an optical magnetic disk, or the like and be provided from the storage device to the computer through a communications line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### DESCRIPTION OF REFERENCE NUMBERS

1: vacancy management system, 10: computer, 100: camera, 200: user terminal

1. A vacancy management system that manages a vacant seat by performing image analysis on a captured image captured by a camera, the vacancy management system comprising:
a captured image acquiring unit that acquires the captured image;
an image analysis unit that performs image analysis on the acquired, captured image;
a first detecting unit that detects how many chairs exist in a table based on an analysis result of the image analysis;
a second detecting unit that detects whether a person is sitting in the chairs based on the analysis result of the image analysis;
a third detecting unit that detects attribute information of the person sitting in the chairs based on the analysis result of the image analysis, the attribute information including order details and a staying time;
an estimating unit that estimates a remaining staying time of a customer from a number of persons in one table, a detecting result of the order details and the staying time, and a detecting result of gender of the person sitting in the chairs, by referring to data regarding a staying time according to a number of customers, a staying time according to order details, and a staying time according to gender of a customer, for customers up to now; and
a vacant seat information display unit that displays vacant seat information and information on the remaining staying time of the customer sitting in the chairs, based on a number of detected chairs and presence or absence of the detected person.

2. The vacancy management system according to claim 1, wherein the vacant seat information display unit changes and displays a degree of attention when all of the detected chairs are vacant.

3. The vacancy management system according to claim 1, wherein the vacant seat information display unit that displays how many vacant seats exist in the table.

4. The vacancy management system according to claim 1, further comprising an attribute information display unit that displays the detected attribute information.

5. The vacancy management system according to claim 1, further comprising:
a user terminal registration unit that registers a user terminal; and
a notification unit that notifies the registered user terminal of the vacant seat information.

6. A vacancy management method that manages a vacant seat by performing image analysis on a captured image captured by a camera, the vacancy management method comprising:
acquiring the captured image;
performing image analysis on the acquired, captured image;
detecting how many chairs exist in a table based on an analysis result of the image analysis;
detecting whether a person is sitting in the chairs based on the analysis result of the image analysis;
detecting attribute information of the person sitting in the chairs based on the analysis result of the image analysis, the attribute information including order details and a staying time;
estimating a remaining staying time of a customer from a number of persons in one table, a detecting result of the order details and the staying time, and a detecting result of gender of the person sitting in the chairs, by referring to data regarding a staying time according to a number of customers, a staying time according to order details, and a staying time according to gender of a customer, for customers up to now; and
displaying vacant seat information and information on the remaining staying time of the customer sitting in the chairs, based on a number of detected chairs and presence or absence of the detected person.

7. A program for causing a vacancy management method that manages a vacant seat by performing image analysis on a captured image captured by a camera to execute:
acquiring the captured image;
performing image analysis on the acquired, captured image;
detecting how many chairs exist in a table based on an analysis result of the image analysis;
detecting whether a person is sitting in the chairs based on the analysis result of the image analysis;
detecting attribute information of the person sitting in the chairs based on the analysis result of the image analysis, the attribute information including order details and a staying time;
estimating a remaining staying time of a customer from a number of persons in one table, a detecting result of the order details and the staying time, and a detecting result of gender of the person sitting in the chairs, by referring to data regarding a staying time according to a number of customers, a staying time according to order details, and a staying time according to gender of a customer, for customers up to now; and
displaying vacant seat information and information on the remaining staying time of the customer sitting in the chairs, based on a number of detected chairs and presence or absence of the detected person.
